(19) United States
(12) Patent Application Publication
(10) Pub. No.: US 2023/0124788 A1
(43) Pub. Date: Apr. 20, 2023

(54) Rotary Transformer

(71) Applicant: Gary William Box, Golden Valley, MN (US)

(72) Inventor: Gary William Box, Golden Valley, MN (US)

(21) Appl. No.: 17/767,704

(22) PCT Filed: Oct. 9, 2020
(86) PCT No.: PCT/US20/55101

§ 371 Date: Apr. 8, 2022

Related U.S. Application Data
(60) Provisional application No. 62/913,708, filed on Oct. 10, 2019.

(51) Int. Cl. H01F 38/18; H01F 27/24; H01F 27/28; H02K 7/08; H02K 11/00

(52) U.S. Cl. CPC H01F 38/18; H01F 27/24; H01F 27/28; H02K 7/08; H02K 11/00

(57) ABSTRACT

A rotary transformer configured to be between a rotor winding and bearing of a wound field synchronous machine and operate within a resonant field device between a rotor winding and bearing of a wound field synchronous machine configured to operate at a frequency of at least 50 kHz within the motor.

### FIELD OF THE INVENTION

This invention relates to a rotary transformer specifically one that is configured to be able to fit between the rotor winding and bearing of a wound field synchronous machine.

### BACKGROUND OF THE INVENTION

Embodiments of device containing a resonant field exciter, U.S. Pat. No. 9,525,376, incorporated herein in its entirety by reference, have been invented for use with wound field machines to allow the machines to perform with the efficiency that approximates permanent magnet field machines. The Resonant Field Exciter (RFE) in the device has a rotary reference frame, a static reference frame, and a resonant circuit comprising in series a resonant capacitor and a rotary transformer with a gap that produces a variable leakage inductance. The RFE is configured to operate in a resonant mode at a resonant frequency of at least 50 kHz to keep its size small enough to be a practical assist to wound field motors without causing the wound field motor with RFE to become impractically large and expensive.

Specifically, the device containing an RFE is described in claim 15 of U.S. Pat. No. 9,525,376 and comprises four elements. The first element is at least one square wave AC voltage generator having a voltage and driving frequency. The second element is at least one resonant field exciter in communication with the square wave AC generator, the resonant field exciter having (1) a rotary reference frame, (2) a static reference frame, and (3) a resonant circuit comprising in series a resonant capacitor and a rotary transformer with a variable leakage inductance. The resonant field exciter is configured to operate in a resonant mode at a resonant frequency of at least 50 kHz. The third element is a controller device in communication with the square wave AC generator and the resonant field exciter and configured to (1) measure the voltage and current into the resonant field exciter, (2) track the resonance frequency, and (3) adjust the driving frequency to substantially match the resonance frequency to maximize AC current transfer. The fourth element is a rectifier in communication with the resonant field exciter and configured to convert the AC current to DC current before it goes into a rotor winding of a wound field synchronous machine.

Commercial components comprising a rotary transformer with rotating and stationary cores are unknown within a wound field synchronous machine between the rotor winding and the bearing operating at greater than 50 kHz. What is known is a rotary transformer inside a wound field generator operating at low frequencies such as 60 Hz. However, these rotary transformers require rotation of the generator shaft by other means such as an engine or turbine to function.

There is a need for a rotary transformer to be used with RFE containing wound field synchronous machine that can be configured within the motor between the rotor winding and a bearing that is able to operate at frequencies of at least 50 kHz.

### SUMMARY OF THE INVENTION

This invention addresses that need with a rotary transformer that is configured to lie within a wound field machine between the rotor winding and a bearing, that can operate at a resonant frequency of at least 50 kHz. This allows for an efficient wound field synchronous machines with the physical components of an RFE within the machine instead of external to it. The rotary transformer of the invention entails two aspects, an article aspect and two method of use aspects.

The article aspect is a rotor transformer able to be inserted within a wound field synchronous machine, allowing at least the rotary transformer portion of the RFE to be within the machine. Specifically, the apparatus comprises three components, a stationary element, a rotating element, and a gap. The stationary element comprises a primary winding and a core made with a material able to be machined and having magnetic properties the same as soft magnetic ferrite. The rotating element comprises a secondary winding and core made with a material able to be machined and having magnetic properties the same as soft magnetic ferrite. The gap is between the stationary element core and the primary element core and has a length. The rotary transformer is configured to operate at a frequency of at least 50 kHz.

The method of using the invention aspect allows one to make and use a wound field synchronous machine, such as a motor or generator, in variable speed situations with at least the rotary transformer portion of an RFE inside the machine between the rotor winding and a bearing.

In one aspect, the rotary transformer is placed in a wound field synchronous machine.

In another aspect, the rotary transformer is placed within a wound field synchronous machine and in communication with other components of the device containing the RFE, as described in claim 15 of U.S. Pat. No. 9,525,376 and discussed above except for the rotary transformer, to form a wound field synchronous machine with an RFE where at least the rotary transformer portion is placed within a wound field synchronous machine. Henceforth “RFE” and “the device containing an RFE described in claim 15 of U.S. Pat. No. 9,525,376” will be used interchangeably

The rotary transformer of the invention permits at least the rotary transformer portion of the RFE to be inside a wound field synchronous machine, between the rotor winding and a bearing in the wound field synchronous machine. This allows for a more compact overall design of the machine in communication with an RFE that is easier to build, operate and maintain. The resulting wound field synchronous machine with at least the rotary transformer of the RFE inside the machine between the rotor winding and a bearing is also more efficient than induction machines and does not have the magnets that are present in permanent magnet machines. Having the mechanical elements of at least the rotary transformer portion of the RFE inside a wound field synchronous machine housing makes for a more robust and appealing machine. The invention may be used in machines ranging from large horsepower machines such as cars to small horsepower machines such as lawnmowers, pumps, glass polishers, and compressors. The rotary transformers of the invention and the machines made with the rotary transformers of the invention offer at least six improvements over the current wound field synchronous machine technology. First, they permit at least the rotary transformer portion of the RFE to be made inside a wound field synchronous machine in a more robust and attractive manner, Second, they extend the practical and economical power limits of wound field synchronous machines that operate from below 10 horsepower to fractional horsepower applications, eliminating the permanent magnets now used in high efficiency wound field synchronous machines in that power range. Third, they enable high efficiency wound field synchronous machines to replace low efficiency induction motors over a broader power range, helping to achieve national energy efficiency goals. Fourth, they reduce the overall size and weight of wound field motors at all power levels. Fifth, they provide functions such as field weakening, direct field control, and monitoring not currently available in permanent magnet motor and generator technology. Sixth, they provide nearly the same high efficiency as permanent magnet motors without the use of permanent magnets.

### BRIEF DESCRIPTION OF THE DRAWINGS

FIG. 1 is a diagram of an embodiment of a stationary element and rotating element and their assembly into a radial gap rotary transformer. Figure A is a cut-away side view of the assembled rotary transformer, Figure B is the top view and side view of the rotating element and Figure C is the top view and the side view of the stationary element.

FIG. 2 is a cut-away side view of a portion of a wound field synchronous machine without a rotor winding that contains the embodiment of a rotary transformer shown in FIG. 1.

FIG. 3 is a cut-away side view of a portion of a wound field synchronous machine with a rotor shaft that contains another embodiment of a rotary transformer with an axial gap.

FIG. 4 is a cut-away exploded perspective view of a wound field machine with a rotary transformer with a radial gap shown in FIG. 2.

While the invention is amenable to various modifications and alternative forms, specifics have been shown by way of example in the drawings and will be described in detail below. It is to be understood, however, that the intention is not to limit the invention to the embodiments described. On the contrary, the invention is intended to cover all modifications, equivalents, and alternatives falling within the scope of the invention as defined by the appended claims.

### DETAILED DESCRIPTION OF SOME EMBODIMENTS OF THE INVENTION

There was a need to place at least the rotary transformer portion of an RFE within a wound field synchronous machine for reasons cited above. The solution was to develop a rotary transformer that is compatible with conventional wound field synchronous machine manufacturing processes and able to operate at frequencies of at least 50 kHz.

One of the most common machine manufacturing processes is the incorporation of a commutator assembly in brush type motors. This commutator assembly provides current to a wound rotor by means physical contact between carbon brushes and a commutator structure mounted on the motor shaft between the rotor and the bearing, positioning the entire assembly inside the motor housing.

The invention, as part of a resonant field exciter described and claimed in U.S. Pat. No. 9,525,376, mimics the commutator assembly by also providing current to a wound rotor although this is accomplished by wireless power transfer rather than physical contact. Processes like installing the commutator assembly can be used to position the rotary transformer invention between the rotor winding and the bearing, inside the motor housing.

This requires the following unique elements of the rotary transformer structure. Specifically, the apparatus comprises three components, a stationary element, a rotating element, and a configuration. The stationary element comprises a primary winding and a core made with a material able to be machined and having magnetic properties the same as soft magnetic ferrite. The rotating element comprises a secondary winding and core made with a material able to be machined and having magnetic properties the same as soft magnetic ferrite and is separated from the stationary element core by a gap with a length. The rotary transformer is configured to operate at a frequency of at least 50 kHz. It also lies between a rotor winding and a bearing of a wound field synchronous motor.

“able to be machined” means in this document that the material has ductile metallic properties that allow is to be formed and shape modified with conventional metal working processes to fit within the varied space between the rotor and bearing of all wound field synchronous machines, and those particularly under 10 horsepower at an operating frequency of at least 50 kHz. This is unlike ferrite that has similar magnetic properties but is too brittle to be formed, shaped, and installed as needed to be installed between the rotor winding and a bearing.

In a wound field synchronous machine, there are two bearings, one on either side of the rotor winding. The rotary transformer of the RFE, whether it has a radial gap or an axial gap, may be between the rotor winding and either bearing to be considered inside the machine.

The need is for a rotary transformer configured to (1) operate at frequencies of at least 50 kHz and (2) be formed and shaped to be inside a wound field motor between the rotor winding and one of two motor bearings is unknown. The configurations of the stationary element core and rotating element core of the rotary transformer of the invention as described above result in a device that is able to operate at frequencies of at least 50 kHz and be machined to be able to fit inside all types of wound field synchronous machines between the rotor winding and one of two motor bearings. This allows for the manufacture of wound field motors with at least the rotary transformer portion of an RFE as taught in U.S. Pat. No. 9,525,376 to be made with the RFE inside the motor.

The gap has a length that may be axial or radial with respect to the axis of the rotating core. Axial gaps are less preferred than radial gaps because of possible axial movement of the shaft of the motor. With axial gaps the gap length may vary with axial movement of the shaft such that the rotating and stational cores may contact each other with catastrophic results. With radial gaps the gap length is insensitive to axial movement of the shaft. The stationary core and the rotating core are shaped and placed together such that the rotating core is within the stationary core and the gap, in the case of the radial gap, is perpendicular to the plane of the axis of the rotating core.

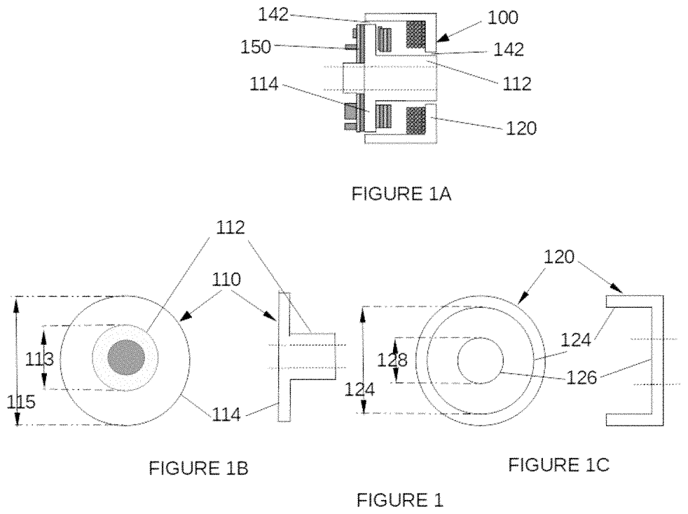

One shape for a radial gap rotary transformer embodiment is a cup and cylinder configuration such as the embodiment shown in FIG. 1. FIG. 1A shows a cut-away side view of the assembled rotary transformer with rotating RFE electronics attached to the rotating element. FIG. 1B shows the front view and side view of the rotating element. FIG. 1C shows the front view and side view of the stationary element. The rotating transformer (100) is shown with its rotating core (110) depicted as a cylinder (112) with a diameter (113) attached to a disc (114) with a diameter (115). The stationary core (120) is a round cup (122) with an inner diameter (124) greater than diameter 115 of disc 114 of rotating core 110 and a hole (126) in the center with a diameter (128) greater than outer diameter 113 of cylinder 112. The radial gap has a length (142) that is one half of the sum of (a) the distance between inner diameter 124 of cup 122 of the stationary element 120 and diameter 115 of disc 114 of rotating element 110 and (b) the distance between inner diameter 128 of hole 126 of stationary element 120 and outer diameter 113 of cylinder 112 of the rotating element 110. Other radial gap shapes are possible. Also shown is the rotating RFE electronics (150)

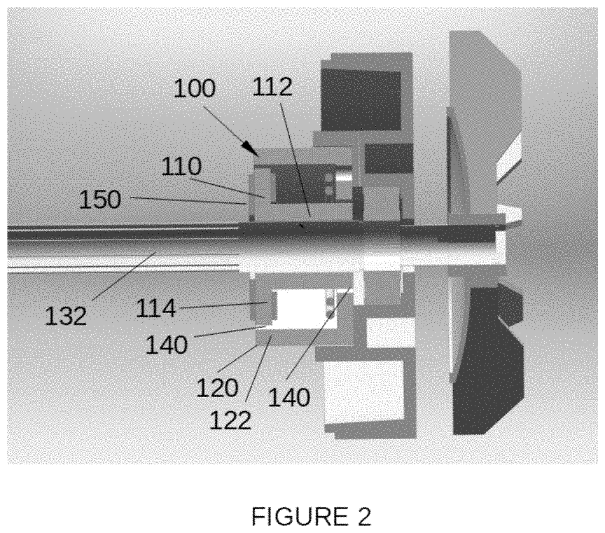

FIG. 2 is a cut-away side view of a portion of a wound field synchronous machine without a rotor winding that contains the embodiment of a rotary transformer shown in FIG. 1. Shown is a side view of the rotary transformer 100 mounted to the shaft (A) of the motor with a rotor winding (B), Shown is rotary element 110 with cylinder 112 attached to disc 114, stationary element 120 with cup 122, and a radial gap 140 in two locations.

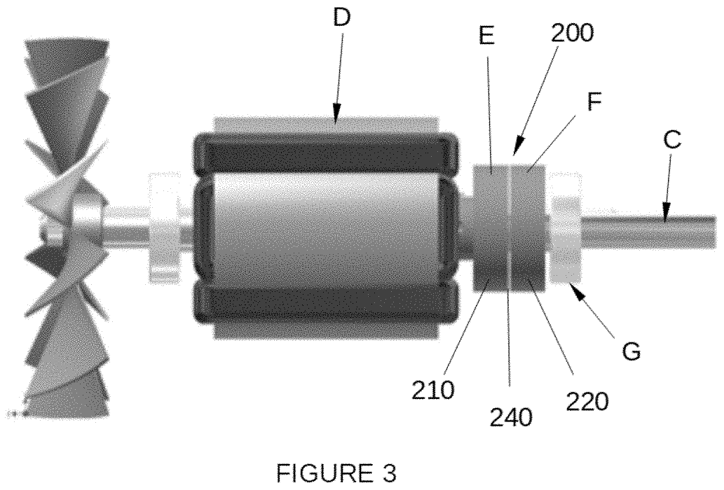

FIG. 3 is a cut-away side view of a portion of a wound field synchronous machine with a rotor shaft that contains another embodiment of a rotary transformer with an axial gap. Shown is a side view of the rotary transformer (200) mounted to the shaft (C)2 of the wound field synchronous machine with a rotor winding (D) and a rotating RFE assembly (E), the stationary RFE assembly (F), and a bearing (G) on both sides of rotary transformer 200. Shown is the rotary element (210), a stationary element (220), and an axial gap (240).

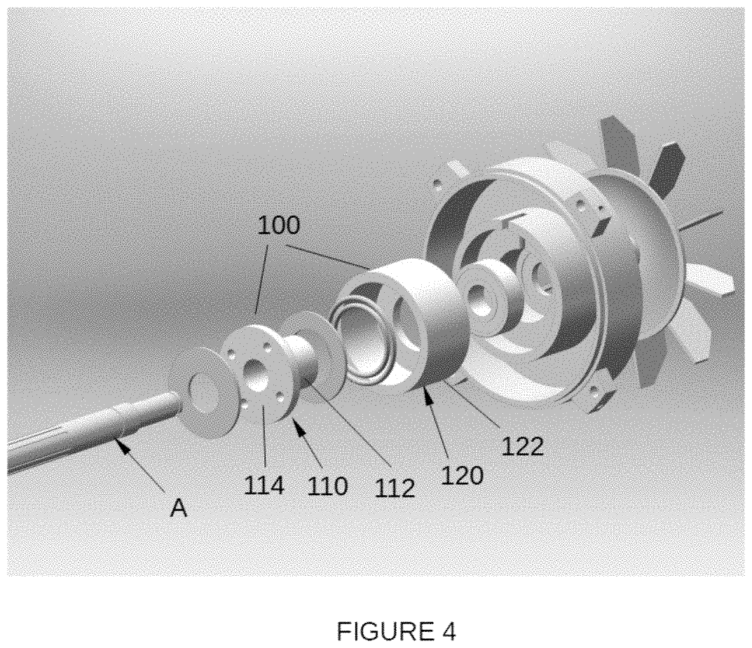

FIG. 4 is a cut-away exploded perspective view of a wound field machine with a rotary transformer with a radial gap shown in FIG. 2. Shown is an exploded side view of the rotary transformer 100 mounted to the shaft (A) of the motor. Also shown is rotary element 110 with cylinder 112 attached to disc 114, stationary element 120 with cup 122.

Both the stationary element and rotating element of the rotary transformer of the invention are made with material able to be machined as defined earlier and is suitable for operating at resonant frequencies of at least 50 kHz. In some embodiments, the material of the stationary core and rotating core comprises a soft magnetic composite of iron particles coated with an electrical resistive coating. While ferrite is able to have the desired magnetic properties, and enable rotary transformers to operate to transfer power at a resonant frequency of at least 50 kHz, it typically does not have the ability to be machined to allow rotary transformers made with ferrite to be installed between the rotor winding and bearings of all wound field synchronous machines. Rotary transformers with stationary elements and rotating elements made from steel are currently suitable to operate at resonant frequencies of around 60 Hz and not over 50 kHz.

The rotary transformer of the invention may be made using conventional manufacturing processes used in the industry to make transformers. Thus, the unique design to the rotary transformer of the invention not only allows for efficient, practical, cost-effective manufacture but also allows the use of at least the rotary transformer portion of the RFE within the wound field synchronous machine for a robust and more tolerant configuration in its many applications.

The second aspect is a method of using the invention in at least two embodiments, a wound field synchronous machine and at least the rotary transformer portion of an RFE containing wound field synchronous machine. The method embodiment of using the invention to make a wound field synchronous machine comprises three steps. The first is to provide a rotary transformer of the invention as described above configured to fit between the rotor winding and bearing of a wound field synchronous machine. The second is to provide a wound field synchronous machine. The third is to place the rotary transformer within the wound field synchronous machine between the rotor winding and the bearing. Such a machine may have additional signaling capabilities by modulating an amplitude, phase and/or frequency of a signal passing through the rotary transformer.

In some embodiments, where an RFE is to be in communication with a wound field synchronous machine, a fourth step and fifth step are needed, The fourth step is to provide all additional physical elements of an RFE r as described in claim 15 of U.S. Pat. No. 9,525,376 except for the rotary transformer. A fifth step is to place the additional elements in communication with the rotary transformer to form at least the rotary transformer portion of a resonant field exciter within the wound field synchronous machine and the RFE in communication with the wound field synchronous machine. The rest may be without the machine.

The second method embodiment comprises five steps. The first is to provide a rotary transformer of the invention as described above configured to fit between the rotor winding and bearing of a wound field synchronous machine. The second is to provide a wound field synchronous machine. The third is to provide all additional physical elements of an RFE as described in claim 15 of U.S. Pat. No. 9,525,376 except for the rotary transformer. The fourth is to place the additional elements in communication with the rotary transformer to form an RFE configured to have at least the rotary transformer portion of the RFE able to reside within the wound field synchronous machine. The fifth is to place at least the rotary transformer portion of the RFE between the rotor winding and the bearing to form a wound field synchronous machine with an RFE. In some embodiments of the above methods, the rotary transformer provided above has a radial gap.

Either an axial gap rotary transformer or a radial gap rotary transformer may be used. However, a radial gap rotary transformer has significant advantages over an axial gap rotary transformer as discussed above.

The various aspects of the invention can better be understood through several figures illustrating some embodiments of the invention. The same numbers will be used to designate the same elements. FIG. 3 shows another embodiment of a wound field synchronous machine with the rotary transformer with an axial gap inside the machine between the rotor winding and a bearing. FIG. 4 is an exploded view of a machine with a rotary transformer with a radial gap between the rotor winding and bearing of a wound field machine

Other modifications and changes made to fit particular operating requirements and environments will be apparent to those with ordinary skill in the art. Thus, the invention is not considered limited to the embodiments discussed for purposes of disclosure and covers all changes and modifications that do not constitute departures from the true spirit and scope of this invention.

1. A rotary transformer, comprising,
a stationary element comprising a primary winding and a core made with a material able to be machined and having magnetic properties the same as soft magnetic ferrite; and
a rotating element comprising a secondary winding and a core made with a material able to be machined and having magnetic properties the same as soft magnetic ferrite; and
a gap between the stationary element core and the primary element core that has a length;
wherein the rotary transformer is configured to operate at a frequency of at least 50 kHz.

2. The rotary transformer of claim 1 wherein the material of the stationary element core and rotating element core comprises a soft magnetic composite of iron particles coated with an electrically resistive coating.

3. The rotary transformer of claim 1 wherein the rotary transformer is configured to be able to fit between a rotor winding and a bearing of a wound field synchronous machine.

4. The rotary transformer of claim 1 wherein the gap is radial

5. The rotary transformer of claim 4
wherein the rotating element comprises a cylinder having a diameter and attached to a disc having a diameter,
wherein the stationary element comprises a round cup having an inner diameter greater than the diameter of the disc of the rotating core and a hole in the center having a diameter greater than the diameter of the outer diameter of the cylinder, and
wherein the radial gap length is half of the sum of (a) the distance between the inner diameter of the cup of the stationary element core and the diameter of the disc of the rotating element core and (b) the distance between the inner diameter of the hole of the stationary element core and the outer diameter of the cylinder of the rotating element core.

6. A method of using a rotary transformer comprising the steps of,
providing a rotary transformer comprising,
a stationary element comprising a primary winding and a core made with a material able to be machined and having magnetic properties the same as soft magnetic ferrite; and
a rotating element comprising a secondary winding and a core made with a material able to be machined and having magnetic properties the same as soft magnetic ferrite; and
a gap between the stationary core and the primary core that has a length,
wherein the rotary transformer is configured to operate at a frequency of at least 50 kHz;
providing the wound field synchronous machine comprising a rotor winding and a bearing; and
placing the rotary transformer between the rotor winding and the bearing of the wound field synchronous machine.

7. A method of using a rotary transformer of claim 6 further comprising the steps of
providing all additional physical elements of a resonant field exciter containing device as described in claim 15 of U.S. Pat. No. 9,525,376 except for the rotary transformer and
placing the additional elements in communication with the rotary transformer to form a resonant field exciter configured to reside within and communicate with the wound field synchronous machine.

8. A method of using a rotary transformer of claim 7 wherein the device containing the resonant field excite comprises
at least one square wave AC voltage generator having a voltage and driving frequency;
at least one resonant field exciter in communication with the square wave AC generator, the resonant field exciter having a rotary reference frame, a static reference frame, and a resonant circuit comprising in series a resonant capacitor and a rotary transformer with a variable leakage inductance, and the resonant field exciter is configured to operate in a resonant mode at a resonant frequency of at least 50 kHz;
a controller device in communication with the square wave AC generator and the resonant field exciter and configured to measure the voltage and current into the resonant field exciter, track the resonance frequency, and adjust the driving frequency to substantially match the resonance frequency to maximize AC current transfer; and
a rectifier in communication with the resonant field exciter and configured to convert the AC current to DC current before it goes into a rotor winding of a wound field synchronous machine.

9. A method of using a rotary transformer of claim 7 wherein the gap is a radial gap having a length.

10. A method of using a rotary transformer comprising the steps of,
providing a rotary transformer comprising,
a stationary element comprising a primary winding and a core made with a material able to be machined and having magnetic properties the same as soft magnetic ferrite; and
a rotating element comprising a secondary winding and a core made with a material able to be machined and having magnetic properties the same as soft magnetic; and
a gap between the stationary core and the primary core that has a length,
wherein the rotary transformer is configured to operate at a frequency of at least 50 kHz;
providing all additional physical elements of a resonant field exciter containing device as described in claim 15 of U.S. Pat. No. 9,525,376 except for the rotary transformer and
providing a wound field synchronous machine comprising a rotor winding and a bearing;
placing the additional elements in communication with the rotary transformer to form a resonant field exciter configured to reside within the wound field synchronous machine;
placing the resonant field exciter between the rotor winding and the bearing to form a wound field synchronous machine with a resonant field exciter within.

11. A method of using a rotary transformer of claim 10 wherein the device containing the resonant field excite4 comprises
at least one square wave AC voltage generator having a voltage and driving frequency;
at least one resonant field exciter in communication with the square wave AC generator, the resonant field exciter having a rotary reference frame, a static reference frame, and a resonant circuit comprising in series a resonant capacitor and a rotary transformer with a variable leakage inductance, and the resonant field exciter is configured to operate in a resonant mode at a resonant frequency of at least 50 kHz;
a controller device in communication with the square wave AC generator and the resonant field exciter and configured to measure the voltage and current into the resonant field exciter, track the resonance frequency, and adjust the driving frequency to substantially match the resonance frequency to maximize AC current transfer; and
a rectifier in communication with the resonant field exciter and configured to convert the AC current to DC current before it goes into a rotor winding of a wound field synchronous machine.

12. A method of using a rotary transformer of claim 10 wherein the gap is a radial gap having a length.
